(19) United States
(12) Patent Application Publication
(10) Pub. No.: US 2016/0053672 A1
(43) Pub. Date: Feb. 25, 2016

(54) FUEL SUPPLY SYSTEM FOR ENGINE

(71) Applicant: Caterpillar Inc., Peoria, IL (US)

(72) Inventors: Andrew J. Loetz, West Lafayette, IN (US); Joel D. Hiltner, Bellingham, WA (US)

(73) Assignee: Caterpillar Inc., Peoria, IL (US)

(21) Appl. No.: 14/933,005

(22) Filed: Nov. 5, 2015

(51) Int. Cl. F02B 19/16; F02D 41/38

(52) U.S. Cl. CPC F02B 19/16; F02D 41/38

(57) ABSTRACT

A fuel supply system for an engine is disclosed. The fuel supply system includes a prechamber assembly in fluid communication with a fuel supply line having a first end and a second end. The prechamber assembly is enclosed within a cylinder head of the engine. The prechamber assembly further includes a pre-combustion chamber located upstream of a main combustion chamber. The pre-combustion chamber is adapted to supply fuel into the main combustion chamber. The prechamber assembly further includes a check valve that is located upstream of the pre-combustion chamber. The fuel supply system further includes a fuel injector that is adapted to fluidly communicate with the check valve of the prechamber assembly. The fuel injector is located upstream of the check valve and in fluid communication with the fuel supply line. The fuel supply system further includes a controller in electric communication with the fuel injector.

### TECHNICAL FIELD

The present disclosure relates to an engine, and more particularly relates to a fuel supply system for the engine.

### BACKGROUND

In order to improve utilization of fuel, an auxiliary chamber, generally referred to as a pre-combustion chamber or a prechamber, is provided in a cylinder head of the engine. The pre-combustion chamber is coupled to the cylinder head in a manner, such that the pre-combustion chamber is in fluid communication with the combustion chamber of the engine. Accordingly, in case of indirect injection, a fuel injector is disposed in the pre-combustion chamber to spray fuel into the pre-combustion chamber, where the fuel mixes with air to form the air-fuel mixture. As such, the combustion initiates in the pre-combustion chamber and subsequently proceeds to the combustion chamber. However, in order to minimize the amount of particulate matter in exhaust from the engine, it should be ensured that all fuel present in the air-fuel mixture is combusted. Accordingly, the air-fuel mixture supplied into the pre-combustion chamber needs to combusted before entering a main combustion chamber of the engine.

U.S. Pat. No. 5,791,374 A ('374 patent) describes a check valve assembly that is adapted to be installed in a pre-combustion chamber for an internal combustion engine. The check valve includes a ball closure element which is responsive to normal fuel/air supply pressure to be held in an open position and is responsive to expansion pressure in the chamber to close the supply line and to prevent back flash of ignited fuel into the supply line. However, the '374 patent does not disclose a process of balancing multi-cylinders in an engine by utilizing a fuel injector.

### SUMMARY OF THE DISCLOSURE

According to an aspect of the present disclosure, a fuel supply system for an engine is described. The fuel supply system includes a prechamber assembly in fluid communication with a fuel supply line having a first end and a second end. The first end of the fuel supply line is connected to an outlet of a fuel reservoir and the second end of the fuel supply line is connected to an inlet of the prechamber assembly. The prechamber assembly is enclosed within a cylinder head of the engine. The prechamber assembly further includes a pre-combustion chamber located upstream of a main combustion chamber. The pre-combustion chamber is adapted to supply fuel into the main combustion chamber. The prechamber assembly further includes a check valve located upstream of the pre-combustion chamber. The check valve moves between a first position and a second position in response to a pressure of the fuel in the fuel supply line and a pressure of air-fuel mixture received in the pre-combustion chamber from the main combustion chamber. The check valve allows flow of the fuel from the fuel supply system to the pre-combustion chamber in the first position and restricts flow of the fuel from the fuel supply system to the pre-combustion chamber in the second position. The fuel supply system further includes a fuel injector adapted to fluidly communicate with the check valve of the prechamber assembly. The fuel injector is located upstream of the check valve and is in fluid communication with the fuel supply line. The fuel supply system further includes a controller in electric communication with the fuel injector. The controller is configured to determine one or more input parameters associated with a combustion event in the cylinder. The controller is configured to control the fuel injector for a predefined time interval based on the one or more input parameters to provide uniform supply of the fuel into the pre-combustion chamber during the combustion event of each cycle in an operation of the engine.

Other features and aspects of this disclosure will be apparent from the following description and the accompanying drawings.

### BRIEF DESCRIPTION OF THE DRAWINGS

FIG. 1 illustrates a partial sectional view of a cylinder head and a cylinder block of an engine, according to one embodiment of the present disclosure;

FIG. 2 illustrates a block diagram of a fuel system of an engine along with cross-sectional view of a pre-combustion chamber of the fuel supply system, according to one embodiment of the present disclosure; and

FIG. 3 illustrates a block diagram of the fuel supply system, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

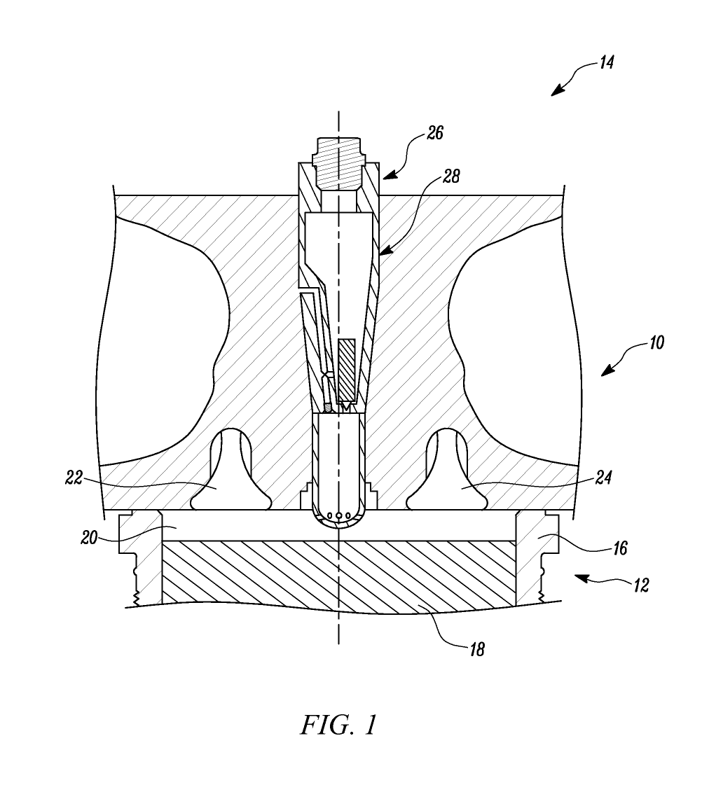

FIG. 1 illustrates a partial sectional view of a cylinder head 10 and a cylinder block 12 of an engine 14. The cylinder head 10 is mounted on the cylinder block 12. In the exemplary embodiment, the engine 14 is a gas engine. In an example, the engine 14 may embody a compression ignition engine, a spark-ignition engine, or any type of combustion engine known in the art. The cylinder block 12 may include multiple cylinders 16. One of the multiple cylinders 16 is shown in FIG. 1. In the case of the multiple cylinders 16, the multiple cylinders 16 may be arranged in an inline configuration, a V-engine, a radial configuration, or any other configurations known in the art. The cylinder block 12 includes a piston 18 disposed within the cylinder 16.

The piston 18 reciprocates between a bottom dead center (BDC) to a top dead center (TDC) in one stroke. One cycle of an operation of the engine 14 includes various strokes, as known in the art, such as suction stroke, compression stroke, expansion stroke and exhaust stroke. A volume between the TDC and the BDC defines a swept volume. The swept volume is indicative of a volume available for a combusted charge to occupy. The phrase “charge” herein may be referred to either as air or a mixture of air and fuel. At TDC of the piston 18, a volume available between the piston 18 and an inner portion of the cylinder head 10 is defined as a main combustion chamber 20.

The cylinder head 10 also includes an inlet port (not shown) to allow the charge into the cylinder 16. The cylinder head 10 includes an inlet valve 22 disposed within the inlet port to supply fuel into the cylinder 16. Once the charge is combusted in the main combustion chamber 20, the products of the combustion are forced out of the cylinder 16 during the exhaust stroke of the piston 18 via an exhaust valve 24. The engine 14 further includes a fuel supply system 26. The fuel supply system 26 includes a prechamber assembly 28 enclosed within the cylinder head 10. The prechamber assembly 28 is provided in the cylinder head 10 to increase a volume of the main combustion chamber 20. In an example, a combustion initiation device, such as a spark plug (not shown) or a fuel injector, disposed in the main combustion chamber 20. In such cases, the prechamber assembly 28 increases volume of the main combustion chamber 20, whilst accommodating the combustion initiation device.

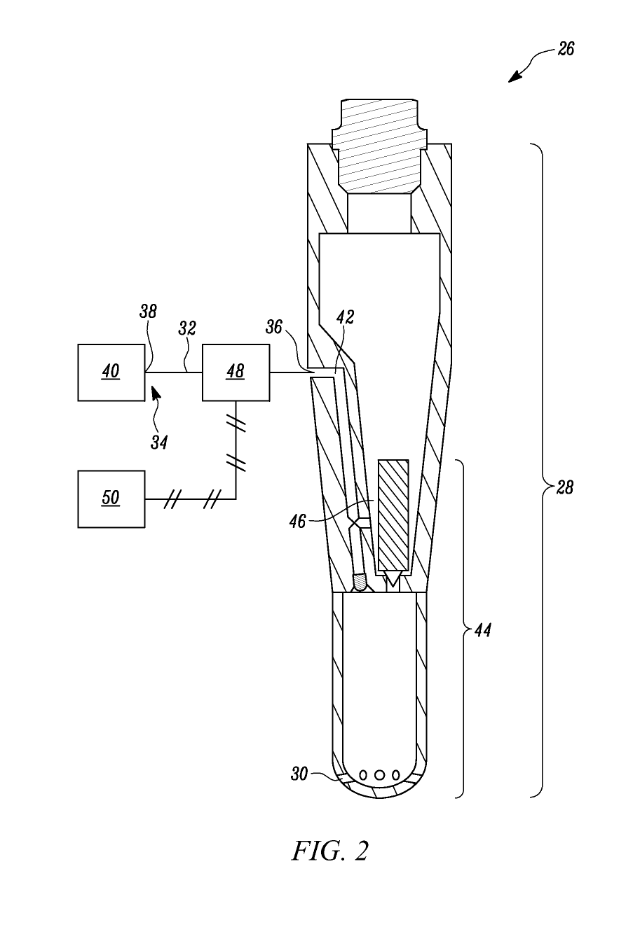

FIG. 2 illustrates an enlarged view of the prechamber assembly 28. In one example, the prechamber assembly 28 may be formed as an inbuilt device with the cylinder head 10. In another example, the prechamber assembly 28 may be a separate device that can be coupled to the cylinder head 10. In the exemplary embodiment, the prechamber assembly 28 is fastened to the cylinder head 10. The air-fuel mixture occupying the prechamber assembly 28 includes lean air-fuel mixture. The lean air-fuel mixture may be understood as a mixture that includes higher stoichiometric amount of air compared to stoichiometric amount of fuel. The prechamber assembly 28 further includes number of openings 30 at a bottom portion of the prechamber assembly 28. The air-fuel mixture drawn into the cylinder 16 is forced into the prechamber assembly 28 through the opening 30, by the piston 18 during the movement from the BDC to the TDC. During the compression stroke, the piston 18 moves from the BDC to the TDC

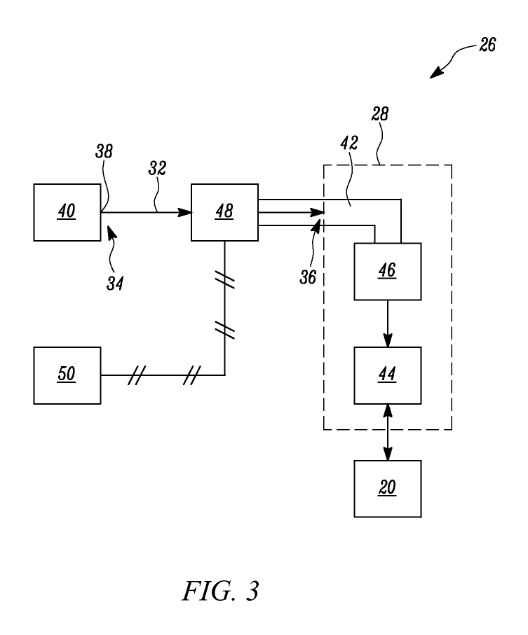

Referring to FIG. 2 and FIG. 3, the fuel supply system 26 includes the prechamber assembly 28 in fluid communication with a fuel supply line 32 having a first end 34 and a second end 36. The first end 34 of the fuel supply line 32 is connected to an outlet 38 of a fuel reservoir 40 and the second end 36 of the fuel supply line 32 is connected to an inlet 42 of the prechamber assembly 28. The fuel supply line 32 transfers fuel from the fuel reservoir 40 to the prechamber assembly 28. The prechamber assembly 28 includes a pre-combustion chamber 44 located upstream of the main combustion chamber 20. The pre-combustion chamber 44 supplies fuel into the main combustion chamber 20 through the number of openings 30. The prechamber assembly 28 further includes a check valve 46 located upstream of the pre-combustion chamber 44. The check valve 46 moves between a first position and a second position in response to a pressure of the fuel in the fuel supply line 32 and a pressure of the air-fuel mixture received in the pre-combustion chamber 44 from the main combustion chamber 20. The check valve 46 allows flow of the fuel from the fuel supply system 26 to the pre-combustion chamber 44 in the first position and restricts flow of the fuel from the fuel supply system 26 to the pre-combustion chamber 44 in the second position.

The fuel supply system 26 further includes a fuel injector 48 in fluid communication with the check valve 46 of the prechamber assembly 28. The fuel injector 48 is located upstream of the check valve 46 and is in fluid communication with the fuel supply line 32. The fuel injector 48 is actuated via an electric system. In an example, the fuel injector 48 may be actuated by a solenoid. In another example, the fuel injector 48 may be actuated either by a hydraulic input, a pneumatic, or mechanical input. It is understood that the fuel injector 48 may be assisted by various components including, but not limited to, a fuel pump, a fuel accumulator, a fuel filter, and a fuel distributor. Thus, the fuel injector 48 may be in fluid communication with one or more of the various components.

The fuel injector 48 atomizes the fuel and supplies the atomized fuel into the prechamber assembly 28. The fuel supply system 26 further includes a controller 50 in electric communication with the fuel injector 48. The controller 50 is disposed at any location in the engine 14. In an example, the controller 50 may be an Electronic Control Unit (ECU). The controller 50 is also in electric communication with various operating parameters of the engine 14, such as a speed of the engine and a load, acting on the engine 14 via one or more sensor devices. The controller 50 communicates with the one or more sensor device to receive a signal indicative of the various operating parameters of the engine 14. The controller 50 further communicates with one or more sensor devices to receive a signal indicative of one or more input parameters associated with a combustion event in the cylinder 16.

In an example, the input parameters associated with the combustion event include a temperature and a pressure of the air fuel mixture combusted during the compression stroke. The controller 50 determines the one or more input parameters associated with the combustion event in the cylinder 16 based on the signal received from the one or more sensor devices. Further, the controller 50 communicates with the fuel injector 48 to control the fuel injector 48 for a predefined time interval based on the one or more input parameters to provide uniform supply of the fuel into the pre-combustion chamber 44 during the combustion event of each cycle in the operation of the engine 14. The predefined time interval is defined as a duration for which the fuel injector 48 is controlled to supply the fuel into the prechamber assembly 28. Further, the predefined time interval is defined based on the one or more input parameters determined by the controller 50.

In an example, the controller 50 may be a processor that includes a single processing unit or a number of units, all of which include multiple computing units. The explicit use of the term ‘processor’ should not be construed to refer exclusively to hardware capable of executing a software application. In this example, the controller 50 may be implemented as one or more microprocessor, microcomputers, digital signal processor, central processing units, state machine, logic circuitries, and/or any device that is capable of manipulating signals based on operational instructions. Among the capabilities mentioned herein, the controller 50 may also be configured to receive, transmit, and execute computer-readable instructions.

### INDUSTRIAL APPLICABILITY

The present disclosure relates to the fuel supply system 26 including the check valve 46 and the fuel injector 48. The pre-combustion chamber 44 receives the air-fuel mixture from the main combustion chamber 20 during the compression stroke. Due to the compression stroke and owing to a substantially small cross-section of the opening 30, the air-fuel mixture entering the pre-combustion chamber 44 from the main combustion chamber 20 is associated with a substantially high pressure. Moreover, all the air-fuel mixture from the main combustion chamber 20 does not enter the pre-combustion chamber 44 due to the substantially small cross-section of the opening 30. As such, a minimal amount of the air-fuel mixture may be forced through the opening 30 due to the movement of the piston 18 from the BDC to the TDC.

The check valve 46 operates based on the pressure of the fuel in the fuel supply line 32 and the pressure of the air-fuel mixture received in the pre-combustion chamber 44 from the main combustion chamber 20. Further, due to the electric communication between the fuel injector 48 and the controller 50, the fuel injector 48 supplies fuel in a uniform manner to the pre-combustion chamber 44 during the combustion event of each cycle (such as suction stroke, compression stroke, expansion stroke and exhaust stroke) during the operation of the engine 14. The fuel injector 48 supplies consistent volume of fuel during each stroke.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fuel supply system for an engine, the fuel supply system comprising:
a prechamber assembly in fluid communication with a fuel supply line having a first end and a second end, the first end of the fuel supply line is connected to an outlet of a fuel reservoir and the second end of the fuel supply line is connected to an inlet of the prechamber assembly, the prechamber assembly enclosed within a cylinder head of the engine, the prechamber assembly including:
a pre-combustion chamber located upstream of a main combustion chamber, the pre-combustion chamber adapted to supply fuel into the main combustion chamber;
a check valve located upstream of the pre-combustion chamber, the check valve moves between a first position and a second position in response to a pressure of the fuel in the fuel supply line and a pressure of an air-fuel mixture received in the pre-combustion chamber from the main combustion chamber, wherein the check valve allows flow of the fuel from the fuel supply system to the pre-combustion chamber in the first position and restricts flow of the fuel from the fuel supply system to the pre-combustion chamber in the second position;
a fuel injector adapted to fluidly communicate with the check valve of the prechamber assembly, the fuel injector located upstream of the check valve and in fluid communication with the fuel supply line; and
a controller in electric communication with the fuel injector, the controller configured to
determine one or more input parameters associated with a combustion event in the cylinder, and configured to
control the fuel injector for a predefined time interval based on the one or more input parameters to provide uniform supply of the fuel into the pre-combustion chamber during the combustion event of each cycle in an operation of the engine.
